(19) United States
(12) Patent Application Publication
(10) Pub. No.: US 2025/0192717 A1
(43) Pub. Date: Jun. 12, 2025

(54) SOLAR AGRITRACKER AND METHOD FOR USING AND/OR CONTROLLING AT LEAST ONE SOLAR AGRITRACKER

(71) Applicant: Johann RAINER, Moosthenning (DE)

(72) Inventors: Stephan RAINER, Plattling (DE); Johann RAINER, Moosthenning (DE)

(21) Appl. No.: 18/844,154

(22) PCT Filed: Mar. 7, 2023
(86) PCT No.: PCT/EP2023/055761

§ 371 Date: Sep. 5, 2024

(30) Foreign Application Priority Data
Mar. 8, 2022 (DE) 20 2022 000 581.4

(51) Int. Cl. H02S 20/32; F16M 11/20

(52) U.S. Cl. CPC H02S 20/32; F16M 11/2021

(57) ABSTRACT

The invention relates to an agricultural solar tracker (1) and to a method for the use and/or control of at least one such agricultural solar tracker (1). The agricultural solar tracker (1) comprises a plurality of solar modules (2), which are arranged so as to be swivelable on a support structure comprising at least one crossed four-bar linkage (25). The crossed four-bar linkage (25) constitutes a support structure for the solar modules (2). The swivel movement of the solar modules (2) about a swivel angle (a) is produced by the at least one crossed four-bar linkage (25), wherein the agricultural solar tracker (1) is designed to swivel the solar modules (2) beyond the middle of a foundation (21) into an end position.

### CLAIM OF PRIORITY

The present application claims priority to International Application PCT/EP2023/055761 filed Mar. 7, 2023, which in turn claims priority to German Utility Model No. 20 2022 000 581.4 filed Mar. 8, 2022, which are incorporated by reference.

### FIELD OF THE INVENTION

The invention relates to a solar tracker, in particular, for the construction of solar parks on agriculturally utilized or agriculturally usable areas. The invention furthermore relates to a method for the use and/or control of at least one such agricultural solar tracker.

### BACKGROUND OF THE INVENTION

In practice, the rows of solar modules or panels use virtually all single-axis horizontal trackers swivel according to the course of the sun via a central axis of rotation that is mounted on supports. When used on agriculturally utilized areas with the intention to continue to use the area between the tracker rows for agricultural purposes, it is usually necessary to set the axes of rotation higher than normal in order to cause less negative impact on the crop plants.

This requires substantially more material in the support structures, that is, in the support posts, as well as a higher installation effort; and, in addition, the solar modules virtually always protrude into the agricultural area, which always represents a high risk of collision risk when agricultural machines drive past.

### SUMMARY OF THE INVENTION

The object of the invention is to prevent the disadvantages mentioned above and to provide an optimal system for the use of solar trackers on agriculturally utilized areas.

The object of the invention is fulfilled by an agricultural solar tracker and a method to use and/or control at least one agricultural solar tracker, the agricultural solar tracker and the method comprising the features in the independent claims. Further advantageous embodiments of the invention are described in the subclaims.

This object is achieved according to claim 1 by the swivel movement of the solar modules about a swivel angle being produced by a crossed four-bar linkage, with the four-bar linkage simultaneously representing the support structure for the solar modules. In this context, the solar modules swivel beyond the middle of the foundation out of the sun-illuminated area into the end position, which is advantageous for large agricultural machines to drive past, and which is also advantageous for plant growth.

The tracker designed in this way is furthermore suitable for partially or fully automated installation.

The above-mentioned advantages can take effect, in particular, with the use of so-called wide-span vehicles, which can preferably cultivate the areas autonomously.

The term “wide-span vehicle” used here refers, in particular, to the type of vehicles used in the agricultural sector that have very wide track widths and attachment spaces situated in between for almost any type of attachments, thus allowing for very large working widths.

The invention furthermore relates to a method for the use and/or control of at least one agricultural solar tracker on an unbuilt site, in particular, on an agricultural area. The term “agricultural area” is to be understood to not only include fields, but also wooded areas, meadows, fallow land overgrown with various plants, wine-growing areas, orchards, etc.

It is provided in the method that one of at least two different setting criteria is taken into account for the swivel movements of the solar modules to be performed in each case and for their inclination settings, specifically:
a) an electrical power output of the solar modules caused by a solar radiation that changes over the course of the day or
b) a space requirement and/or a shading requirement for the site caused by the use of the installation site of the agricultural solar tracker and/or by the use of the site adjacent to or next to the particular installation site of the agricultural solar tracker and/or caused by agricultural operations.

For the first case, that is, for an electrical power output of the solar modules to be optimized, it can be particularly useful to change the inclination of the solar modules, which are normally designed as photovoltaic elements, along with the position of the sun changing over the course of the day, for example, by selecting the angle of incidence approximately such that the electrical power output of the solar modules is maximized over as long a period of the daytime as possible. Under certain circumstances, however, such a control specification is not always useful if other control criteria are also to be taken into account, such as a reduction of maximum and minimum power output with simultaneous homogenization of the power output of the solar modules.

For the second case that can be taken into account, that is, the space requirement and/or a shading requirement for the site caused by the use of the installation site of the agricultural solar tracker and/or by the use of the site adjacent to or next to the particular installation site of the agricultural solar tracker and/or caused by agricultural operations, it can be particularly useful to coordinate the inclination adjustment of the solar modules to the requirements of the adjacent plants, as these plants possibly require more shading at certain times of the day, while requiring more solar radiation at other times of the day. These requirements may exist in certain climate regions, for example, for wine growing or for the cultivation of other crop plants.

Further conceivable scenarios can consist, for example, in using the solar modules as a shield from heavy rainfall for crops to be protected from such heavy rainfall.

One embodiment of the method provides that areas of different widths are defined between agricultural solar trackers that are arranged in rows. In particular, a first width for agricultural areas is defined on the basis of a width of an agricultural machine that is suitable for the corresponding agricultural use or on the basis of the desired use. In addition, a second width is defined for spacing areas, with in each case one spacing area being arranged between two adjacent agricultural areas, and with the second width of the spacing areas being defined on the basis of an installation width of the agricultural solar tracker.

The agricultural solar trackers can thus be allocated smaller or larger portions of the area to take up within an agricultural area. If the focus is on generating electrical energy, the agricultural solar trackers can cover larger portions, leaving correspondingly narrower strips for agricultural use between the spacing areas with the trackers installed on them. This can mean, for example, that the agricultural solar trackers take up a portion of 40% or more of the agricultural area, or even more than 60%.

However, if the focus is on agricultural use, it may be expedient to reduce the portions of the areas with agricultural solar trackers installed on them, so that wider strips correspondingly remain for agricultural use between the spacing areas with the trackers installed on them. This can mean, for example, that the agricultural solar trackers take up a portion of 25% or less of the agricultural area, or even less than 15%.

Another embodiment of the method provides that a plurality of agricultural solar trackers are arranged in parallel rows. In this context, the solar modules of agricultural solar trackers arranged on adjacent spacing areas, between which a cultivation of the corresponding agricultural area is to be carried out by an agricultural machine, can each be swiveled in opposite directions to one another, In particular, a swiveling into an end position can be carried out, in which end position a distance between the agricultural machine and a base of the agricultural solar tracker is less than a distance between the agricultural machine and the solar modules of the agricultural solar tracker.

In this context, it can be an expedient condition to clear the parts that protrude laterally beyond an anchoring of the agricultural solar tracker and into the agricultural area. An anchoring of the agricultural solar tracker can be formed, for example, by a ground foundation, ground screws, ground anchors or the like.

As the agricultural solar trackers are swivelable by a four-bar linkage swivel mechanism, they allow solar modules to be swiveled, if required, in such a manner that a risk of collision with an agricultural machine driving over the agricultural area as well as with its attachments can be reduced by the solar modules being swiveled to the side, in each case facing away from the area to be cultivated.

An additional or alternative condition can provide for the removal of parts of the solar modules or of their suspensions from a defined vertical shadow profile. In this context, the shadow profile can be expediently defined by a rectangle of which the lateral width between adjacent agricultural areas corresponds approximately to the width of the anchoring, with the agricultural areas being spaced apart from each other by a spacing area with an agricultural solar tracker arranged thereon. The length of the shadow profile in this context preferably corresponds to the space requirement of an agricultural solar tracker, limited by adjacent solar modules of other agricultural solar trackers within the spacing area.

One embodiment of the method provides that all swivel actions can be specified centrally by a computer control system and/or in communication with an agricultural machine driving over the field, in particular, in communication with a working machine or towing machine. In this context, it can be additionally defined that the agricultural machine or the working machine or towing machine can either drive autonomously by GPS data-supported control and/or can be controlled centrally by a computer. The computer-controlled driving mode, in turn, can preferably be carried out with the help of GPS location coordinates.

A central control and/or data communication of the adjustment mechanisms for the agricultural trackers with the agricultural machine driving over the agricultural area enables the solar modules to be in each case swiveled at the right point in time so that they pose no risk of collision. This likewise ensures that they are in each case swiveled to the correct side without involving any significant loss of electrical power yield, as they can be returned to their starting position after the agricultural machine has passed, where they again meet the criterion of the electrical energy generation to be optimized.

Another embodiment of the method can provide the solar modules to be swivelable into defined positions in a time-controlled manner in order to temporarily shade the agricultural crops cultivated on the agricultural areas, and/or it can provide the solar modules to be swivelable into defined positions in a controlled manner in order to temporarily protect the agricultural crops cultivated on the agricultural areas against precipitation and/or wind.

According to the plants that are being cultivated, the solar modules can thus generate an additional benefit that goes beyond the pure generation of electrical energy. Certain types of wine or other crop plants do not thrive equally under all climatic conditions, as, for example, the solar radiation can be too intense or the precipitation too high over the course of the year. If the solar modules are used in a suitable manner as shading elements and/or shielding elements in such cases, the conditions for cultivation and utilization of such sensitive plants can potentially be improved in specific regions to the degree that effective agricultural use is made possible which would normally not be possible or only possible to a limited extent for this species and/or variety of plants at a given location.

Another embodiment of the method can provide that the agricultural areas are used for fruit growing or wine growing, with the first width of the agricultural areas being selected according to a width that is necessary for a row of fruit trees or grape vines, and with the swivel movement of the solar modules being controlled over the day in such a manner that a shading of the fruit trees or grape vines is carried out at predefined points in time.

Another embodiment of the method can provide that the swivel movement of the solar modules is regulated in consideration of a regional or cross-regional total power requirement in the power grid, in particular, wherein a control of the inclination of the solar modules is optimized with regard to an electrical power output that is homogenized over the course of the day. It can thus be expedient, for example, in regions with strong solar radiation, not to aim for the maximum possible electrical power yield at all times, but rather to keep the total power output of a larger number of solar modules within certain limits, for example.

It should be explicitly mentioned at this point that all aspects and embodiment variants explained in the context of the apparatus according to the invention can likewise pertain to or constitute partial aspects of the method according to the invention. If specific aspects and/or interrelations and/or effects relating to the apparatus according to the invention are referred to at some point in the present description or in the claims definitions, this therefore likewise pertains to the method according to the invention. The same applies conversely, so that all aspects and embodiment variants explained in the context of the method according to the invention can likewise pertain to or constitute partial aspects of the device according to the invention. If specific aspects and/or interrelations and/or effects relating to the method according to the invention are referred to at some point in the present description or in the claims definitions, this therefore likewise pertains to the apparatus according to the invention.

### BRIEF DESCRIPTION OF THE FIGURES

In the following passages, the attached figures illustrate in further detail exemplary embodiments of the invention and its advantages. The size ratios of the individual elements in the figures do not necessarily reflect the real size ratios. It is to be understood that in some instances various aspects of the invention may be shown exaggerated or enlarged to facilitate an understanding of the invention.

FIG. 1 shows a schematic illustration of the agricultural solar tracker.

FIG. 2 shows a schematic illustration of the agricultural solar tracker in a front view.

FIG. 3 shows a schematic illustration of the four-bar linkage with a drive, the four-bar linkage constituting a support element.

FIG. 4 shows a schematic illustration of the agricultural solar tracker that is swiveled in a front view.

FIG. 5 shows a schematic illustration of a partial segment of the agricultural solar tracker in a perspective view.

FIG. 6 shows a schematic perspective illustration of the four-bar linkage with a drive, the four-bar linkage constituting a support element.

FIG. 7 shows a schematic illustration of the four-bar linkage with a drive, the four-bar linkage constituting a support element, with a section indicated in the illustration.

FIG. 8 shows a schematic illustration of a section through the drive area.

FIG. 9 shows a schematic perspective illustration of a section through the drive area.

FIG. 10 shows a schematic illustration of the four-bar linkage without a drive, the four-bar linkage constituting a support element.

FIG. 11 shows a schematic illustration of the double four-bar linkage with a drive, the double four-bar linkage constituting a support element.

FIG. 12 shows an enlarged schematic illustration of the double four-bar linkage with a drive, the double four-bar linkage constituting a support element.

FIG. 13 shows a schematic illustration of the agricultural solar tracker with a central tube.

FIG. 14 shows a schematic illustration of the agricultural solar tracker with a foundation.

FIG. 15 shows a schematic illustration of the agricultural solar tracker constituting an agricultural tracker.

FIG. 16 shows a schematic illustration of the agricultural solar tracker and an agricultural machine driving past.

FIG. 17 shows a schematic illustration of the agricultural solar tracker in combination with the use of a wide-span vehicle.

FIG. 18 shows a schematic illustration of the agricultural solar tracker with the use of a wide-span vehicle in a front view.

FIG. 19 shows a schematic illustration of a wide-span vehicle in transverse drive or in longitudinal drive mode.

FIG. 20 shows a schematic illustration of the agricultural solar tracker with the use of a wide-span vehicle in a transverse lane.

### DETAILED DESCRIPTION OF THE INVENTION

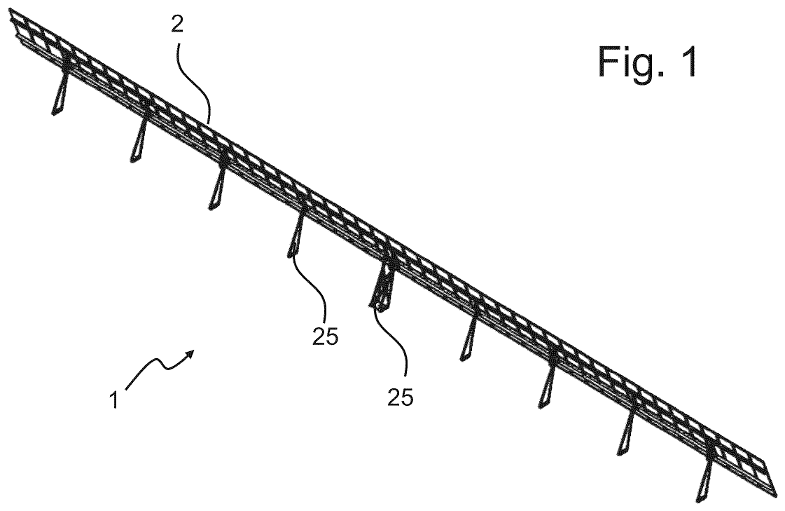

The schematic perspective view in FIG. 1 illustrates an agricultural solar tracker 1, illustrated here as a table, which contains the elements described and illustrated in more detail in the following figures.

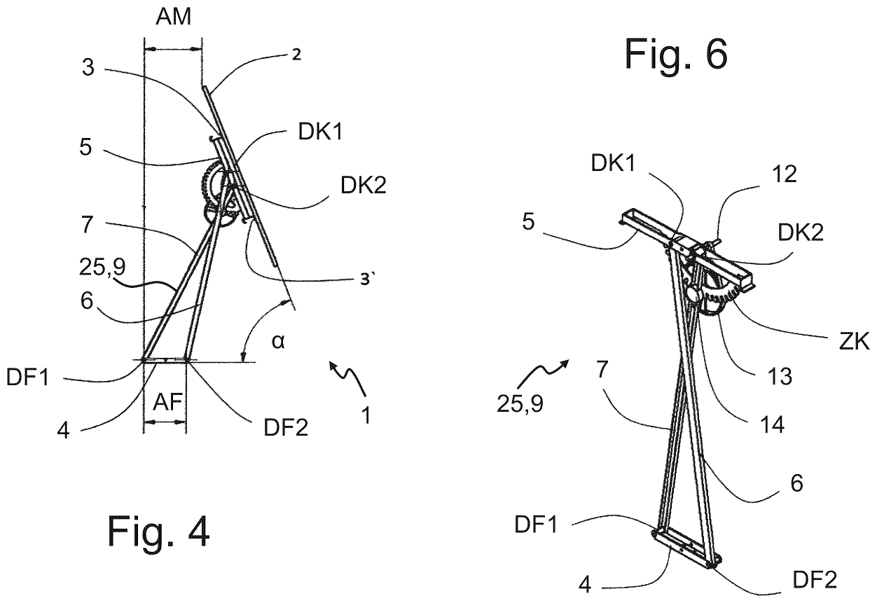

In the present context, a multitude of solar modules 2 are arranged on a plurality of four-bar linkage structures 25. The solar modules are arranged so as to be swivelable on a structure comprising at least one crossed four-bar linkage or comprising at least one four-bar linkage structure 25. The crossed four-bar linkage or four-bar linkage structure 25 constitutes a support structure for the solar modules 2. The swivel movement of the solar modules about a swivel angle (a, cf. FIG. 4) is produced by the at least one crossed four-bar linkage. The agricultural solar tracker 1 is designed to swivel the solar modules 2 beyond the middle of a foundation into an end position.

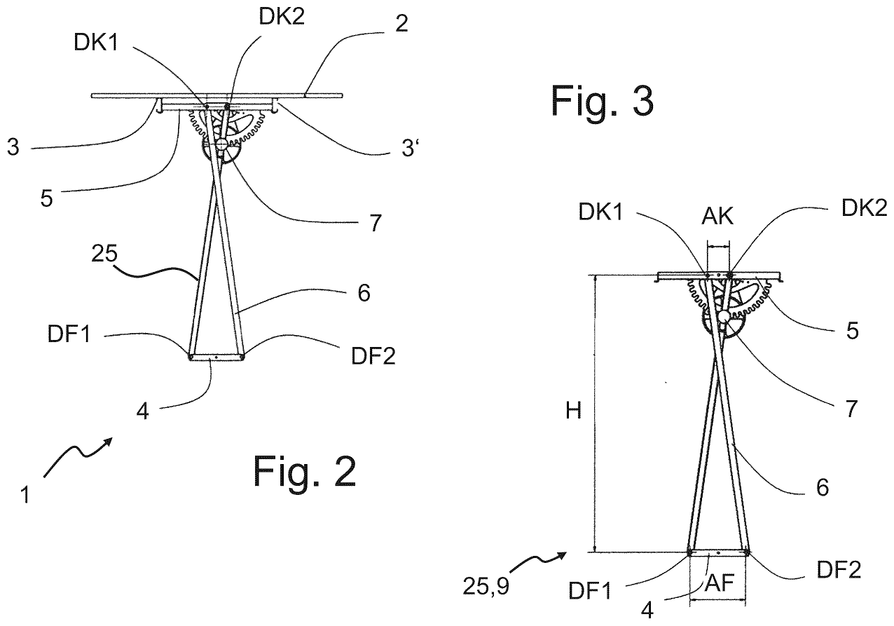

The FIG. 2 shows a schematic illustration of the agricultural solar tracker 1 in a front view, which shows the basic structure of an embodiment in the area of a four-bar linkage structure 25. The four-bar linkage structure 25 comprises a bottom base plate 4 with two axes of rotation, in particular a first axis of rotation DF1 assigned to the base plate 4, and a second axis of rotation DF2 assigned to the base plate 4, with the support strut 6 being mounted in the second axis of rotation DF2 assigned to the base plate 4, and with the support strut 7 with a drive being mounted in the first axis of rotation DF1 assigned to the base plate 4.

The agricultural solar tracker 1 furthermore comprises a head section 5 with a first axis of rotation DK1 assigned to the head section 5 and a second axis of rotation DK2 assigned to the head section 5, with the support strut 6 being mounted in the first axis of rotation DK1 assigned to the head section 5, and with the support strut 7 with a drive being mounted in the second axis of rotation DK2 assigned to the head section 5. The head section 5 supports module carriers 3 and 3′ on which the solar modules 2 are mounted.

The FIG. 3 shows a schematic illustration of an embodiment of a four-bar linkage structure 25, which serves as a support element and is equipped with a drive. The four-bar linkage structure 25 with a drive has the reference number 9 in the following passages. The four-bar linkage 9 has a head section height H that can vary according to the growth heights of the planned crop plants.

According to a preferred embodiment variant of the invention, the distance AF, which is formed between the first axis of rotation DF1 arranged on the base plate 4 and the second axis of rotation DF2 arranged on the base plate 4, and the distance AK, which is formed between the first axis of rotation DK1 arranged at the head section and the second axis of rotation DK2 arranged at the head section, are of different sizes, which size difference results in the swivel movement for the solar modules 2.

The FIG. 4 shows a schematic illustration of the agricultural solar tracker 1 in the area of a four-bar linkage 9, that is, in the area of a four-bar linkage structure 25 with a swiveled arrangement of the solar modules in a front view. It is discernible in this context that the solar module 2, in being swiveled about a swivel angle α, can be swiveled by a module spacing AM beyond the first axis of rotation DF1 arranged on the base plate, and that the module spacing AM can thus be greater than the distance AF. This applies in both swivel directions, that is, with a positive and with a negative swivel angle α.

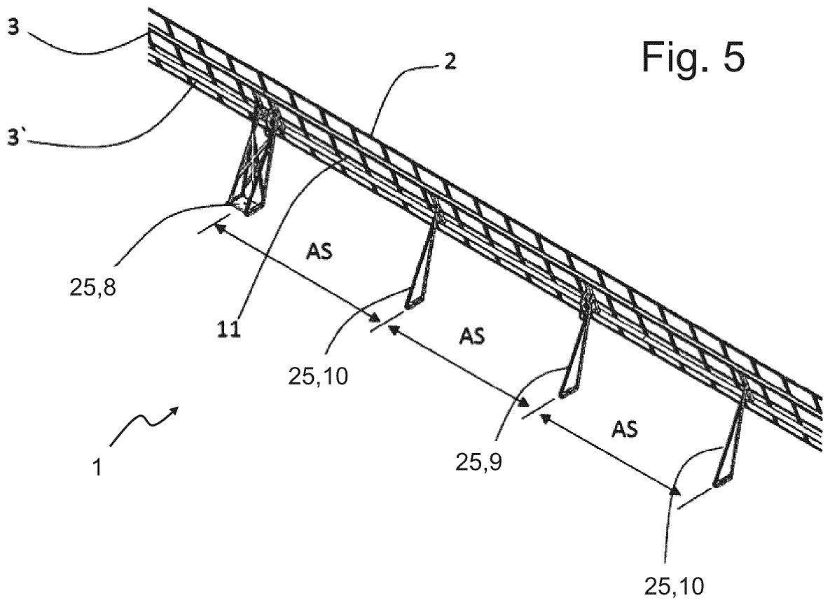

The FIG. 5 shows a schematic illustration of a partial segment of the agricultural solar tracker 1 in a perspective view, and thus the basic structure of a below-described embodiment of a four-bar linkage structure 25 in the form of a double four-bar linkage 8, a below-described embodiment of a four-bar linkage structure 25 in the form of a four-bar linkage 10 without a drive, and an above-described embodiment of a four-bar linkage structure 25 in the form of a four-bar linkage 9 with a drive, which four-bar linkage structures 25 are connected to each other via the module carriers 3, 3′, on which module carriers 3, 3′ the solar modules 2 are in turn mounted.

A drivetrain 11 extends through the particular axes of rotation DK2 assigned to the second head section in order to drive the entire system of the agricultural solar tracker 1, in which context the drivetrain 11 drives one or more tables of an agricultural solar tracker 1 preferably extending on both sides from a drive motor 17. The drive motor is not illustrated in the FIG. 5. The spacing AS between the four-bar linkages 25 is also not relevant for the design according to the invention, as the spacing can be selected individually depending on the local conditions such as wind and ground, as well as depending on the loads from the solar modules 2 and other parameters.

According to a preferred embodiment variant of the present invention, however, the four-bar linkage structures 25, also referred to as four-bar linkage supports, are designed in the form of double four-bar linkages 8, four-bar linkages 10 without drives, and four-bar linkages 9 with drives, which are described in FIGS. 2 to 4 and in the figures below.

The FIG. 6 shows a schematic perspective illustration of the four-bar linkage 9 with a drive, the four-bar linkage 9 constituting a support element according to FIG. 3, and the FIG. 6 thus showing all the basic elements of this four-bar linkage 9. The base plate 4, which comprises the first axis of rotation arranged on the base plate and the second axis of rotation arranged on the base plate, can be attached to any suitable foundation adapted to the local ground conditions.

Mounted thereon are the support strut 6 and the support strut 7 with a drive, the head section 5 with a gear ring with the first axis of rotation DK1 arranged at the head section 5 and the second axis of rotation DK1 arranged at the head section 5, at which first axis of rotation DK1 arranged at the head section 5 the support strut is mounted and on which second axis of rotation DK2 arranged at the head section 5 the support strut 7 with a drive is mounted.

It is furthermore discernible from FIG. 6 that a gear ring ZK forms a component of the head section 5 with the gear ring ZK anchored to it, and also a through-drive shaft 12, and, extending from it, a reduction stage 13, which comprises a drive 14 for the gear ring ZK, preferably in the form of a step gear. In this context, the reduction stage 13 can also be designed with multiple stages if required, which is, however, not shown here.

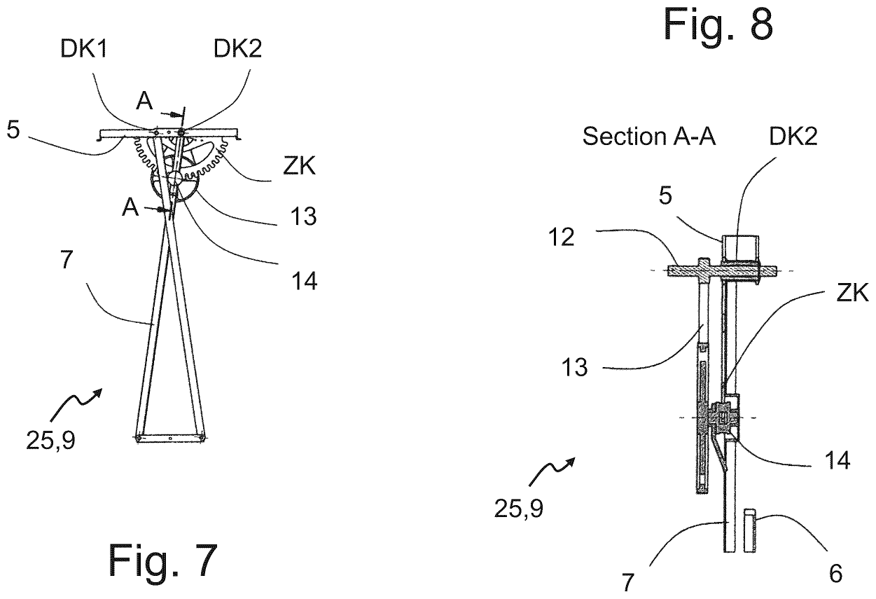

The FIG. 7 shows a schematic illustration, with a section indicated for the following FIG. 8, of the four-bar linkage 9 with a drive, the four-bar linkage constituting a support element.

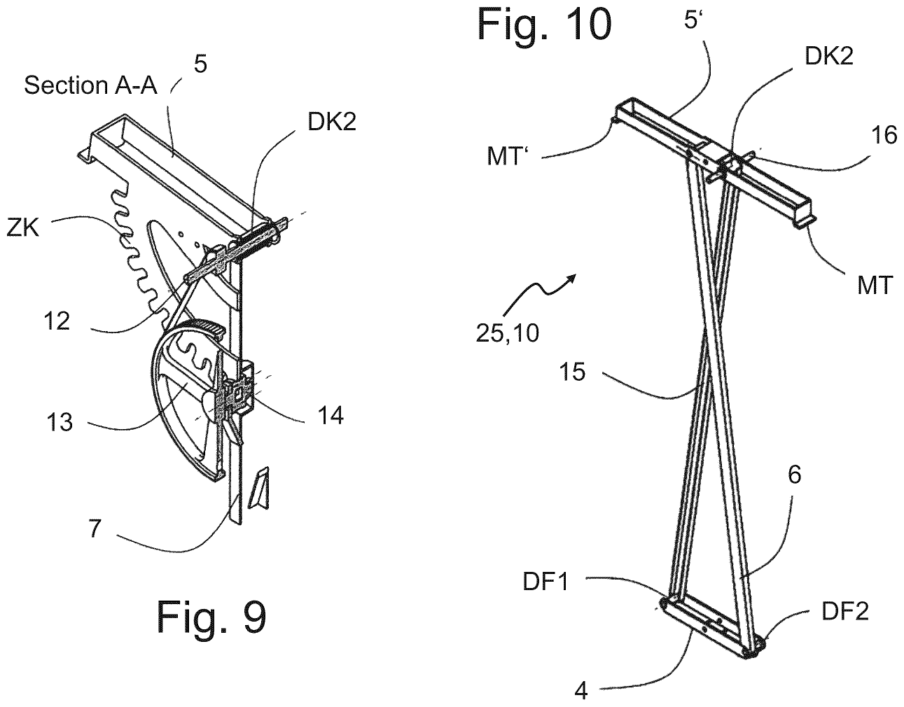

The FIG. 8 shows a schematic illustration of a section A-A through the drive area of a four-bar linkage 9 with a drive, and the FIG. 9 shows a schematic, perspective illustration of a section A-A through the drive area of a four-bar linkage 9 with a drive. The section A-A shows the coaxial bearing of the through-drive shaft 12 according to the invention within the second axis of rotation DK2 arranged at the head section 5, which axis of rotation DK2 is a component of the head section 5 with gear ring ZK, as is the gear ring ZK itself. Extending from the through-drive shaft 12, a reduction stage 13 drives a drive 14 for the gear ring ZK, which drive 14 is mounted in the support strut 7 and engages in the ring gear ZK.

In this context, a step gear is preferably used, which blocks the four-bar linkage structure 9 in the 0° position of the solar modules (not illustrated in FIGS. 8 and 9) and thus ensures a secure footing for the agricultural solar tracker 1, for example during storms.

The FIG. 10 shows a schematic perspective illustration of the four-bar linkage 10 without a drive, the four-bar linkage 10 constituting a support element, and the FIG. 10 thus showing all the basic elements of this four-bar linkage 10, in particular, the base plate, the two axes of rotation, in particular, the first axis of rotation DF1 arranged on the base plate 4 and the second axis of rotation DF2 arranged on the base plate 4, two support struts, in particular, a first support strut 6 and a second support strut 15 with through-drive, a head section 5′ without a gear ring with a first axis of rotation DK1 arranged at the head section 5′ and a second axis of rotation DK2 arranged at the head section 5′, in which second axis of rotation DK2 arranged at the head section 5′ a through-drive shaft 16 without an output is in turn coaxially mounted. Additionally discernible in the figure are two module carrier supports MT and MT′, which can also be part of the head sections 5 and 5′, but which are not described as such in more detail here, as they are fitted to the module carriers (cf. FIG. 2).

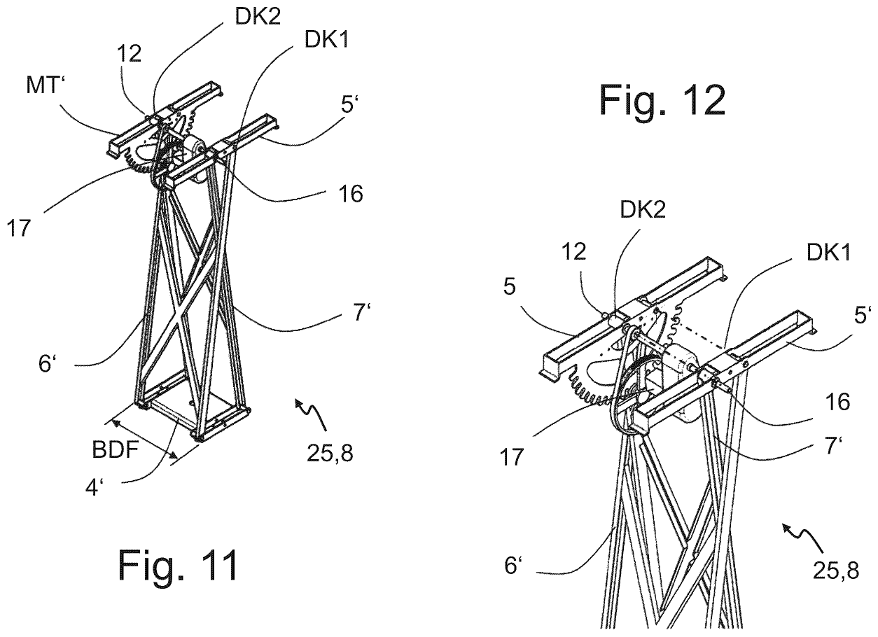

The FIG. 11 shows a schematic illustration of a double four-bar linkage 8 with a drive 17, the double four-bar linkage 8 constituting a support element. In order to absorb lateral forces acting on the solar modules (cf. FIG. 1), this support element provided by the double four-bar linkage 8 is equipped with a double base plate 4′, which double base plate 4′ has a width BDF, is braced with a first braced support strut 6′, and is equipped with a second support strut 7′ equipped with a drive. In the upper area of the braced support strut 6′ and the braced support strut 7′ equipped with a drive, the head section 5 with a gear ring ZK and the head section 5′ without a gear ring are attached to the axis of rotation DK2 via the first axis of rotation DK1 arranged at the head section 5, 5′ and via the second axis of rotation DK2 arranged at the head section 5, 5′. Between the through-drive shaft 12 and the through-drive shaft 16 without an output, any type of drive motor 17 can be installed as a drive for a drivetrain extending from here.

The FIG. 12 shows a schematic illustration, in which the upper area of the head section 5 with a gear ring ZK and the head section 5′ without a gear ring is enlarged, and which shows the double four-bar linkage 8 with a drive 17, the double four-bar linkage constituting a support element. Discernible in this context are the first axis of rotation DK1 arranged at the head section 5, 5′ and the second axis of rotation DK2 arranged at the head section 5, 5′, as well as the first axis of rotation DF1 arranged on the base plate 4 and the second axis of rotation DF2 arranged on the base plate 4, via which all support elements, that is, the double four-bar linkage 8, the four-bar linkage 10 without a drive, and the four-bar linkage 9 with a drive, always run coaxially to each other.

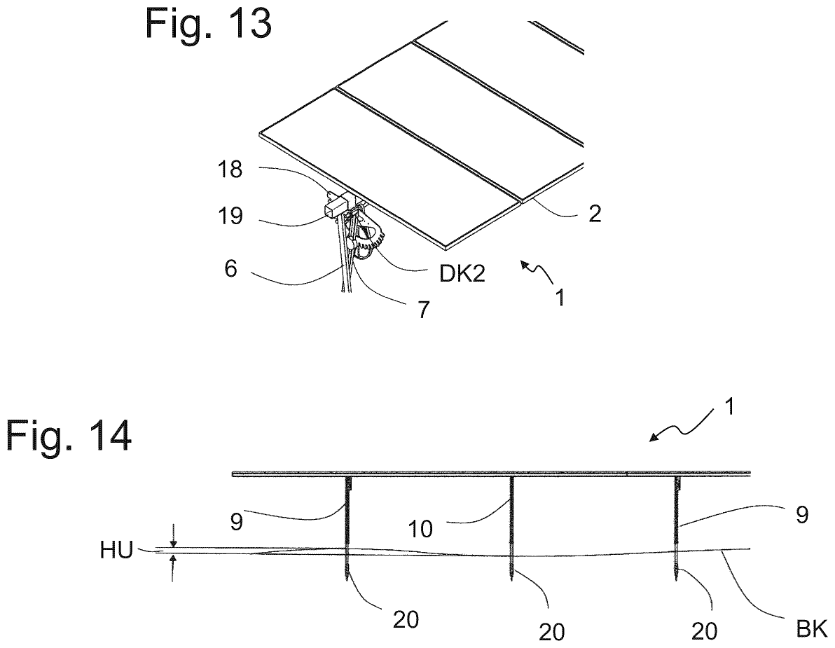

The FIG. 13 shows a schematic illustration of a detail of an embodiment of an agricultural solar tracker 1 with a central tube 19 connecting the four-bar linkage structures 25. In this context, a four-bar linkage 9 with a drive is discernible, which indicates a head section 18 for a central tube 19 with a gear ring ZK and the therein integrated second axis of rotation DK2. This embodiment can be a useful and necessary alternative for configurations of solar modules 2, and it shows, in particular, the adaptability of the system.

The FIG. 14 shows a schematic illustration of an embodiment of an agricultural solar tracker 1 with foundations 20, which are shown to be designed as screw foundations in the illustrated exemplary embodiment. It is advantageous to use such screw foundations, as they are also able to absorb tensile forces. Since all axes of rotation DK1, DK2, DF1, and DF2 of the support elements, in particular, of the double four-bar linkages 8 (not illustrated here), the four-bar linkages without a drive 10, and the four-bar linkages with a drive 9, must always run coaxially within an agricultural solar tracker unit 1, height differences HU in the ground contour BK must be compensated for by the foundation 20. At the same time, since all system elements above the foundation 20 are always the same, this also benefits an automated assembly.

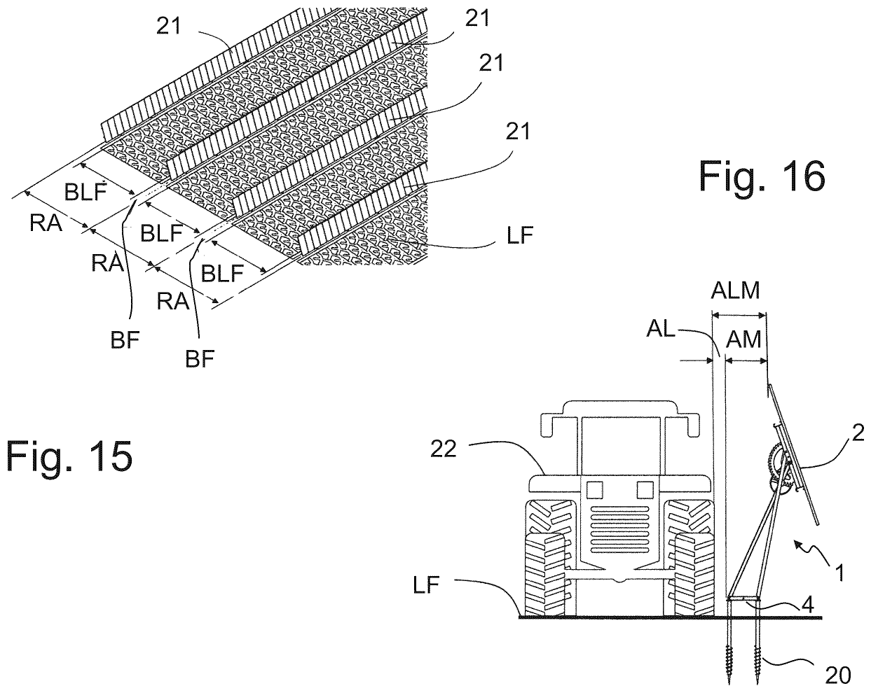

The FIG. 15 shows a schematic illustration of the use of a plurality of agricultural solar tracker units 1 as agricultural trackers on an agricultural area LF, on which the rows of agricultural solar trackers 21 can be installed with a freely selectable row spacing (RA). The agricultural area LF minus a base area of the base strip width BF can continue to be used over the width BLF of the agricultural area between the rows of agricultural solar trackers 21.

The FIG. 16 shows a schematic illustration of the use of an agricultural solar tracker 1 and an agricultural machine 22 driving past, whereby the advantage of the swivel movement by the four-bar linkage concept is illustrated. The module spacing AM makes it possible to maintain a large distance ALM between the agricultural machine 22 and the solar modules 2 even with a very small distance AF between the agricultural machine 22 and the base 4. On the one hand, this facilitates the cultivation of the agricultural areas LF so that these can be optimally utilized.

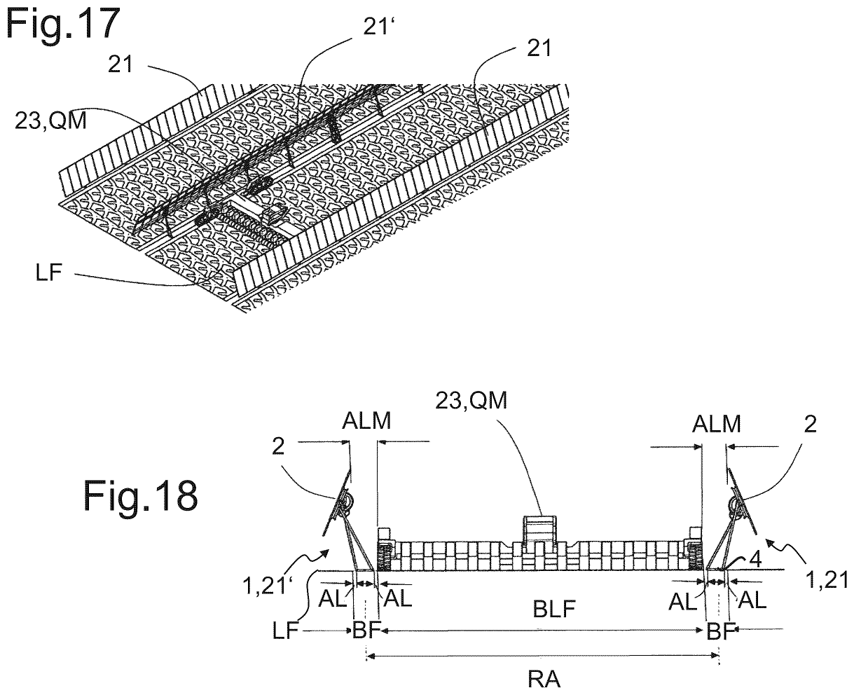

The FIG. 17 shows a schematic illustration of a plurality of agricultural solar tracker rows 21, 21′ in combination with the use of a wide-span vehicle 23. In this context, the wide-span vehicle 23 in each case drives over the agricultural area between two rows of agricultural solar trackers 21, 21′, with the solar modules 2 of the agricultural solar tracker rows 21 being arranged counter-swiveled to the solar modules 2 of the particular adjacent agricultural solar tracker rows 21′. In this way, the advantage described in FIG. 16 of safely driving past both rows of agricultural solar trackers 21, 21′ can be utilized and the agricultural area LF can be optimally cultivated.

The FIG. 18 shows a schematic illustration of two agricultural solar tracker rows 21, 21′ with the use of a wide-span vehicle 23 in a front view. The FIG. 18 shows that only one base strip of the width BF is required for the agricultural solar tracker system, here in the form of the agricultural solar tracker row 21 and the agricultural solar tracker row 21′, in each case with counter-swiveled solar modules 2, that is, solar modules 2 swiveled in opposite directions to one another, in which base strip the distance AL between the agricultural machine, in particular the wide-span vehicle 23, and the base 4 is also in each case included to the left and right of the agricultural solar tracker row 21, 21′. The width BLF of the agricultural area (LF, cf. FIG. 17) then results according to the selected row spacing RA, the width BLF preferably being adapted to common working widths of agricultural machinery.

Another advantage is that the distance AL between the agricultural machine and the base 4 can be reduced to a few centimeters, especially for autonomous or GPS-controlled vehicles such as a wide-span vehicle 23, while at the same time providing for a large distance ALM between the agricultural machine and the solar module 2.

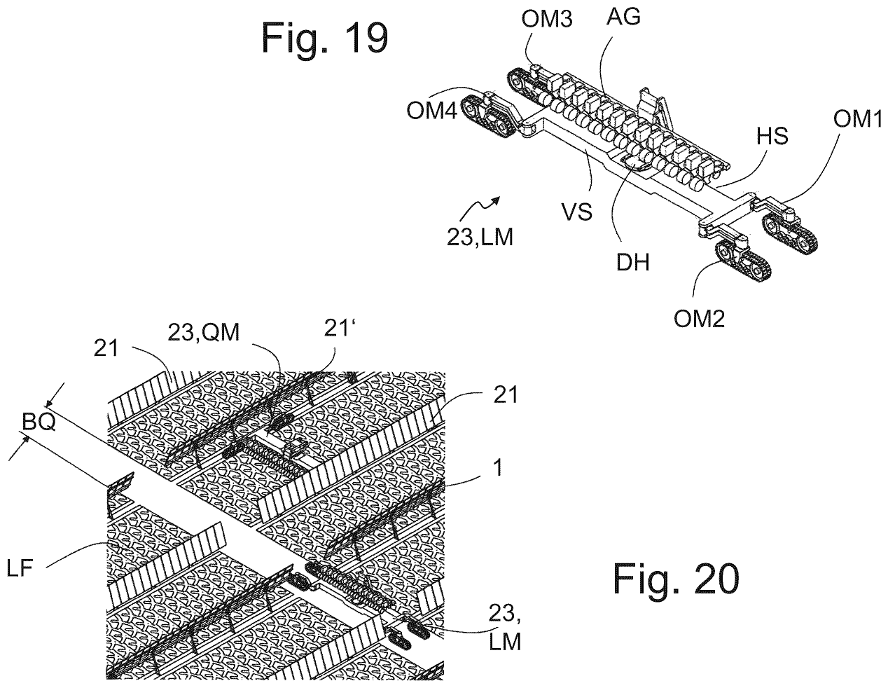

The FIG. 19 shows a schematic illustration of a wide-span vehicle 23 in a longitudinal drive mode LM, which is advantageous, for example, for road travel or for changing over from row lane to row lane. The wide-span vehicle 23 is equipped with four omnidirectional driving gears OM1 to OM4 and with a rotary lifting device DH, so that the wide-span vehicle 23 can be operated both in longitudinal drive LM and in transverse drive QM (cf. FIGS. 17 and 18).

The illustration in the FIG. 19 furthermore shows a stylized attachment AG in a position that is raised so that a rotation of any attachment AG from the front VS of the wide-span vehicle 23 to the rear HS of the wide-span vehicle is possible. This has the advantage that a wide-span vehicle 23 does not have to turn at the headlands of the agriculturally utilized areas, but merely changes the driving direction.

FIG. 20 shows a schematic illustration of the agricultural solar tracker 1, in particular, a plurality of agricultural solar tracker rows 21, 21′. Illustrated in this context is the use of a wide-span vehicle 23 in transverse drive mode QM between two agricultural solar tracker rows 21, 21′, which makes clear the advantage of not having to turn, as described in FIG. 19.

The wide-span vehicle 23 can be converted to a longitudinal drive mode LM in order to drive from row lane RG to row lane RG on a very narrow driving lane of the width BQ. In this context, a row lane RG corresponds to the agricultural area LF between the agricultural solar tracker rows 21, 21′ with in each case counter-swiveled solar modules 2, whereby the proportion of agricultural area LF can be increased. It is preferably provided that a wide-span vehicle 23 can in each case automatically and by the omnidirectional driving gears OM1 to OM4 take up the suitable longitudinal drive mode LM or transverse drive mode and change the driving direction. It is also preferably provided that rows of agricultural solar trackers 21, 21′ in each case automatically swivel the solar modules 2 in opposite directions depending on the position of one or more wide-span vehicles 23 on the agricultural area LF. This is preferably carried out in a manner controlled by a superordinate system control of such a solar park.

A final note should be made at this point with regard to the descriptions of embodiment variants of the invention, with these passages of the description in each case referring to the attached drawings. If illustrations and aspects are generally referred to as being “schematic” in the context of the figures and the above descriptions, this is by no means intended to imply that the illustration of the figures and their description are of inferior significance with regard to the disclosure of the invention. The person skilled in the art is fully capable of gathering sufficient information from the schematically and abstractly drawn illustrations for facilitating the understanding of the invention without the understanding being in any way impaired by, for example, the size ratios being drawn and being potentially not precisely true to scale. On the basis of the more concretely explained realizations of the method according to the invention and on the basis of the more concretely explained functionality of the apparatus according to the invention in the figures, the reader as a person skilled in the art is thus enabled to derive a better understanding of the inventive idea, which is formulated in a more general and/or more abstract manner in the claims and in the general part of the description.

The invention has been described with reference to a preferred embodiment. However, it is conceivable to a person skilled in the art that modifications or changes to the invention can be made without departing from the scope of protection of the following claims.

### LIST OF REFERENCE NUMBERS

1 Agricultural solar tracker
2 Solar module
3 and 3′ Module carrier
4 Base plate
4′ Double base plate
5 Head section with a gear ring
5′ Head section without a gear ring
6 (First) support strut
6′ (First) support strut, braced
7 (Second) support strut with a drive
7′ (Second) support strut with a drive, braced
8 Double four-bar linkage
9 Four-bar linkage with a drive
10 Four-bar linkage without a drive
11 Drivetrain
12 Through-drive shaft
13 Reduction stage
14 Drive for the gear ring/gear ring drive
15 (Second) support strut with through-drive
16 Through-drive shaft without an output
17 Drive motor
18 Head section for central tube with a gear ring
19 Central tube
20 Foundation
21 Row of agricultural solar trackers/agricultural solar tracker row
21′ Row of agricultural solar trackers/agricultural solar tracker row, counter-swiveled
22 Agricultural machine
23 Wide-span vehicle
25 Four-bar linkage structure
DF1 First axis of rotation arranged on the base plate
DF2 Second axis of rotation arranged on the base plate
DK1 First axis of rotation arranged at the head section
DK2 Second axis of rotation arranged at the head section
H Height of head section/head section height
AF Distance between the first axis of rotation DF1 arranged on the base plate and the second axis of rotation arranged on the base plate:
AK Distance between the first axis of rotation arranged at the head section and the second axis of rotation arranged at the head section:
AM Module spacing
AL Distance between the agricultural machine and the base
ALM Distance between the agricultural machine and the modules
AS Spacing between the four-bar linkage supports
α Swivel angle
ZK Gear ring
MT and MT′ Module carrier support
BK Ground contour
HU Height difference
LF Agricultural area
RA Row spacing
BDF Width of the double base plate
BLF Width of the agricultural area
BF Width of the base strip
BQ Width of the driving lane
DH Rotary lifting device
VS Front of the wide-span vehicle
HS Back of the wide-span vehicle
AG Attachment
OM1 to OM4 Omnidirectional driving gear
QM Transverse drive, transverse drive mode
LM Longitudinal drive, longitudinal drive mode
RG Row lane

1. An agricultural solar tracker (1) comprising:
a plurality of solar modules (2), which are arranged so as to be swivelable on a support structure comprising at least one crossed four-bar linkage (25), wherein the at least one four-bar linkage (25) swivels the plurality of solar modules (2) about a swivel angle (α), wherein the support structure swivels the solar modules (2) such that a module spacing distance (AM) is created between the solar modules (2) and an axis of rotation (DF1, DF2).

2. An agricultural solar tracker (1), comprising:
a plurality of support structures for a plurality of solar modules (2) adapted to move in a swivel angle (α) in both directions, each support structure comprising a crossed four-bar linkage structure, with each four-bar linkage structure comprising:
(a) a base plate (4) with a first axis of rotation (DF1) and a second axis of rotation (DF2),
(b) a head section (5) with a first axis of rotation (DK1), a second axis of rotation (DK2), and a gear ring (ZK),
(c) a support strut (6), which is rotatably mounted in the second axis of rotation (DF2) assigned to the base plate (4) and in the first axis of rotation (DK1) assigned to the head section (5), and
(d) a support strut (7) rotatably mounted in the first axis of rotation (DF1) assigned to the base plate (4) and in the second axis of rotation (DK2) assigned to the head section (5), and
a drivetrain comprising at least one drive (9) and a through-drive shaft (12) extending along the second axis of rotation (DK2) in a plurality of the head sections (5), wherein the through-drive shaft (12) drives the gear ring (ZK) of each head section (5) to swivel the solar modules (2).

3. The agricultural solar tracker (1) of claim 14, wherein at least one of the support structures further comprises: (a) a a head section without a gear ring (5′), (b) an integrated module carrier supports (MT and MT′), or (c) a central tube (18) parallel with the second axis of rotation (DK2).

4. The agricultural solar tracker (1) of claim 3 further comprising a plurality of rows of solar modules (2).

5. The agricultural solar tracker (1) of claim 4, wherein the plurality of rows of solar modules (2) comprise at least three rows of solar modules (2).

6. (canceled)

7. (canceled)

8. The method claim 15, wherein the swiveling step is performed on a plurality solar modules (2) arranged in parallel rows, wherein adjacent rows of solar modules are swiveled in opposite directions to each other.

9. The method claim 15, further comprising controlling the swivel step from a stationary or mobile control system.

10. The method 9, wherein the wherein the control system swivels one or more solar modules (2) into defined positions to provide shade to agricultural crops cultivated near the solar modules (2), or to protect agricultural crops cultivated near the solar modules (2) against precipitation or wind.

11. The method of claim 10, wherein the cultivated agricultural crops are.

12. The method of claim 9, wherein the control system swivels one or more solar modules (2) in consideration of a power requirement in a power grid.

13. The solar tracker (1) of claim 1, wherein a distance (AF) between a first axis of rotation (DF1) and a second axis of rotation (DF2) is less than the module spacing distance (AM).

14. The solar tracker (1) of claim 2 wherein the drivetrain (11) further comprises a gear reduction (13) between the through-drive shaft (12) and the gear ring (ZK).

15. A method comprising:
swiveling a plurality of solar modules (2) about a second axis of rotation (DK2) assigned to a head section (5) of a support structure, wherein the support structure further comprises:
(a) a base plate (4) with a first axis of rotation (DF1) assigned to the base plate (4) and a second axis of rotation (DF2) assigned to the base plate (4),
(b) a head section (5) with a first axis of rotation (DK1) and a gear ring (ZK),
(c) a support strut (6), which is rotatably mounted in the second axis of rotation (DF2) assigned to the base plate (4) and in the first axis of rotation (DK1) assigned to the head section (5), and
(d) a support strut (7) rotatably mounted in the first axis of rotation (DF1) assigned to the base plate (4) and in the second axis of rotation (DK2) assigned to the head section (5),
wherein the swiveling step comprises driving the gear ring (ZK) with a drivetrain comprising at least one drive (9) and a through-drive shaft (12) extending along the second axis of rotation (DK2) in a plurality of the head sections (5).

16. The method of claim 8, where in a distance between a module spacing distance (AM) is created between the solar modules (2) and the first axis of rotation (DF1) or second axis of rotation (DF2).

17. The method of claim 16, wherein a distance (AF) between the first axis of rotation (DF1) and the second axis of rotation (DF2) is less than the module spacing distance (AM).

18. The method of claim 9, wherein the control system swivels one or more solar modules (2) in response to the presence or absence of an operating machine located near one or more of the solar modules (2).
